(19) United States
(12) Patent Application Publication
(10) Pub. No.: US 2008/0162974 A1
(43) Pub. Date: Jul. 3, 2008

(54) Universal serial bus host controller

(76) Inventor: John S. Keys, Beaverton, OR (US)

Correspondence Address: INTEL CORPORATION;c/o INTELLEVATE, LLC, P.O. BOX 52050, MINNEAPOLIS, MN, 55402, US

(21) Appl. No.: 11/648,254

(22) Filed: Dec. 29, 2006

(51) Int. Cl. G06F 1/04

(52) U.S. Cl. 713/400

(57) ABSTRACT

In some embodiments a signal is sent to start a current time frame for a Universal Serial Bus host controller. After the sending, a time period is entered during which a pending transaction may be transmitted by the host controller. If a transaction has been formed, the formed transaction is transmitted during the entered period. When less than a maximum transfer period remains between a current time and a start of a next time frame, there is a refraining from transmitting any additional formed transactions during the current time frame. Other embodiments are described and claimed.

### TECHNICAL FIELD

The inventions generally relate to Universal Serial Bus (USB) host controllers.

### BACKGROUND

Universal Serial Bus (USB) is a serial bus standard used to interface devices. USB was originally designed for computers, but its popularity has prompted it to also become commonplace on other devices such as, for example, video game consoles, portable digital assistants (PDAs), portable digital video disk (DVD) and media players, cell phones, televisions (TVs), home stereo equipment such as MP3 players and iPods, car stereos, and portable memory devices. USB can be used to connect peripherals such as mouse devices, keyboards, gamepads, joysticks, scanners, digital cameras, printers, external storage, networking components, and many other devices. USB is used to connect several devices to a host controller (HC) through a chain of hubs.

Previous efforts relating to USB host controller (HC) development have gone into making USB HCs bigger and faster and adding as many additional ports as possible. Light weight USB HCs do not currently exist. However, this direction does not appear to be appropriate for the emerging embedded application market for USB. Current USB HCs are designed to support all possible devices and to support up to 127 different devices. These HCs require significant memory and central processing unit (CPU) resources to service efficiently. This acts as a barrier to entry for many potential embedded USB applications, since the cost of adding a full-featured HC.

### BRIEF DESCRIPTION OF THE DRAWINGS

The inventions will be understood more fully from the detailed description given below and from the accompanying drawings of some embodiments of the inventions which, however, should not be taken to limit the inventions to the specific embodiments described, but are for explanation and understanding only.

FIG. 1 illustrates a Universal Serial Bus Host Controller according to some embodiments of the inventions.

FIG. 2 illustrates a timing diagram according to some embodiments of the inventions.

FIG. 3 illustrates a state diagram according to some embodiments of the inventions.

### DETAILED DESCRIPTION

Some embodiments of the inventions relate to Universal Serial Bus (USB) host controllers.

In some embodiments a signal is sent to start a current time frame for a Universal Serial Bus host controller. After the sending, a time period is entered during which a pending transaction may be transmitted by the host controller. If a transaction has been formed, the formed transaction is transmitted during the entered period. When less than a maximum transfer period remains between a current time and a start of a next time frame, there is a refraining from transmitting any additional formed transactions during the current time frame.

In some embodiments a Universal Serial Bus host controller includes a set of registers, a memory to buffer read data or written data, and a processor. The processor is able to send a signal to start a current time frame, after the sending, to enter a period during which a pending transaction may be transmitted by the host controller, if a transaction has been formed, to transmit the formed transaction during the entered period, and when less than a maximum transfer period remains between a current time and a start of a next time frame, to refrain from transmitting any additional formed transactions during the current time frame.

In some embodiments, a system includes a USB host controller and a USB device coupled to the USB host controller (for example, via a USB cable). The USB host controller is able to send a signal to start a current time frame, after the sending, to enter a time period during which a pending transaction may be transmitted by the host controller, if a transaction has been formed, to transmit the formed transaction during the entered period, and when less than a maximum transfer period remains between a current time and a start of a next time frame, to refrain from transmitting any additional formed transactions during the current time frame.

In some embodiments an article includes a computer readable medium having instructions thereon which when executed cause a computer to send a signal to start a current time frame for a Universal Serial Bus host controller, after the sending, to enter a period during which a pending transaction may be transmitted by the host controller, if a transaction has been formed, to transmit the formed transaction during the entered period, and when less than a maximum transfer period remains between a current time and a start of a next time frame, to refrain from transmitting any additional formed transactions during the current time frame.

For many embedded applications, USB is attractive as a well-known two-wire interface. USB properties that would be desirable in embedded applications include the actual transport. The plug-n-play and wide range of device support properties of USB are not as desirable in embedded applications. In such applications, there is typically only one device and it is hard-wired in place. In some embodiments, a USB host controller (HC) enables this type of use by providing a simple-to-program host-end controller for USB signaling while removing the need to provide full USB support of all known devices. In some embodiments, an example of the potential proliferation of such a use is a simple Wi-Fi® security configuration proposed by Microsoft Corp. and Intel Corp. This model allows users to transfer security certificates between Wi-Fi® nodes using USB flash drives. The model would proliferate very quickly if adding a single-purpose HC to each node was a reasonable and cost effective addition (for example, to each Wi-Fi® node such as access points, routers, and other types of headless equipment).

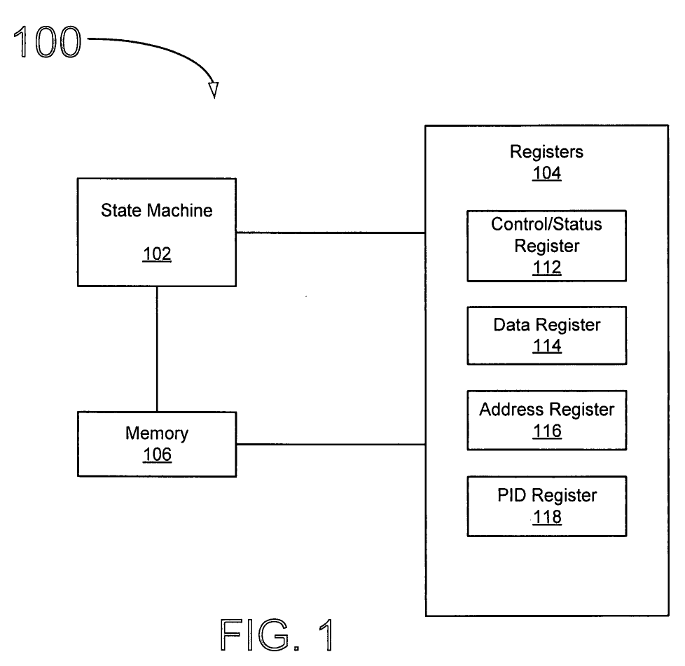

FIG. 1 illustrates a USB host controller (HC) 100 according to some embodiments. In some embodiments USB host controller 100 is an entire USB HC and/or in some embodiments USB HC 100 is a USB HC engine for use in embedded applications. In some embodiments USB HC 100 includes a state machine 102 (for example, a timer-driven transaction state machine), registers 104 (for example, a small bank of registers for controlling individual transactions and collecting the result), and a memory 106 (for example, a small block of memory to buffer the read and/or written data).

In some embodiments state machine 102 may be implemented in software, hardware, and/or firmware (including any combination of one or more thereof. In some embodiments state machine 102 may be implemented using a processor.

In some embodiments, registers 104 include a control/status register 112, a data register 114, an address register 116, and/or a PID (physical interface devices) register 118. In some embodiments, control/status register 112 includes Data Length (for example, ten bits to allow for USB2 high-speed), Direction (for example, one bit to indicate read/write), GO (for example, one bit to signal transaction start), ERR (for example, one bit to indicate error completion), BUSY (for example, one bit to indicate current state of the HC), ENA (for example, one bit to enable/disable the HC), and/or RST (for example, one bit to drive USB reset signaling on wire). In some embodiments, data register 114 is a transaction buffer, which can, for example, be implemented in many different possible currently accepted ways for implementing buffer access. In some embodiments, address register 116 provides addressing components for generated transaction, for example, including ENDPT (for example, four bits to encode a target endpoint number), and/or ADDR (for example, seven bits to encode a target device address). In some embodiments, PID register 118 provides transaction type components for a generated transaction, including for example, TOKEN (for example, eight bits to encode a transaction token such as IN, OUT, SOF, and/or SETUP, etc.), SENDPIC (for example, eight bits to encode the transaction PID such as DATA0, DATA1, ACK, NAK, and/or STALL, etc.), and/or RCVPID (for example, eight bits for latching a PID code returned by the device and/or valid upon transaction completion).

In some embodiments a timer-driven state machine (for example, state machine 102) has three states, including a “Send SOF” (Start of Frame) state, a “Send Pending Transaction” state, and a “Wait for SOF” state. These states provide a way of simply avoiding “babble”, the condition where a party continues to transmit beyond the end of the current frame.

In some embodiments, the timer period between successive “Send SOF” states corresponds to the nature of the USB frame time of the target device (for example, 125 usec for High Speed USB or 1 ms for Full Speed USB). In this state, the USB HC broadcasts a single SOF token to an attached device. The USB HC advances to the “Send Pending Transactions” state upon completion of sending the SOF token, for example.

In some embodiments, in the “Send Pending Transactions” state, the USB HC waits for indication that a transaction has been formed. This is indicated, for example, by host software writing a “GO” bit in the USB HC registers. When this “GO” bit is set, the USB HC will transmit the formed transaction. If the direction bit indicates an “OUT” direction, then the USB HC will also capture the response token of the device in a register. If the direction bit indicates an “IN” direction, the USB HC will capture the returned data to the memory buffer (for example, memory 106). Once the transaction is complete, the USB HC checks the timer. If enough time remains to execute another maximum size transaction, then the USB HC returns to polling the “GO” bit for another transfer.

In some embodiments, the USB HC moves to the “Wait for SOF” state when less than a maximum buffer transfer period remains between the present time and the start of the next time frame, thus preventing a babble condition. The USB HC waits in this state until the timer move it to the “Send SOF” state and the cycle restarts.

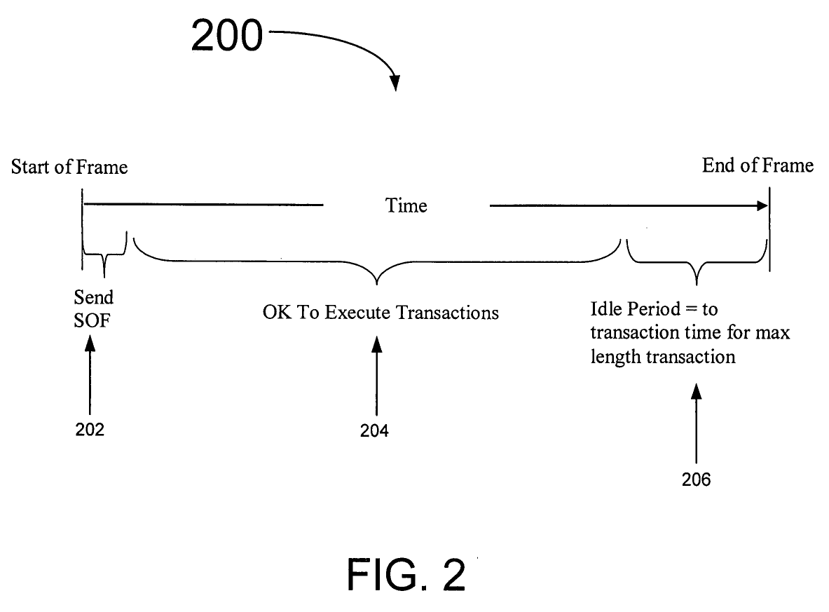

FIG. 2 illustrates a timing diagram 200 according to some embodiments. Timing diagram 200 (for example, a USB HC time frame diagram) illustrates a time period between a “Start of Frame” time and an “End of Frame” time, including a “Send SOF” time period 202, an “OK to Execute Transactions” time period 204, and an “Idle Period” 206 that is equal to the transaction time for a maximum length transaction. In some embodiments, the “Send SOF” time period 202 corresponds to the “Send SOF” state, the “OK to Execute Transactions” time period 204 corresponds to the “Send Pending Transactions” state, and/or the “Idle Period” 206 corresponds to the “Wait for SOF” state.

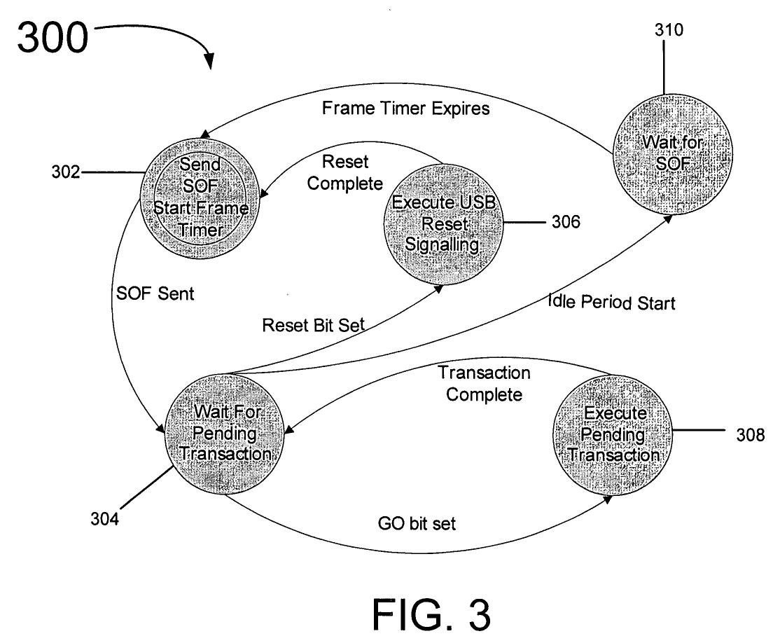

FIG. 3 illustrates a state diagram 300 according to some embodiments. State diagram 300 includes a “Send SOF” state 302, a “Wait for pending transaction” state 304, an “Execute USB Reset signaling” state 306, an “Execute Pending Transaction” state 308, and/or a “Wait for SOF” state 310. At state 302, a SOF (Start of Frame) signal is sent and/or a frame timer is started. Then at state 304 the state machine waits for a pending transaction. If the “Reset” bit is set at state 304, then a USB reset signaling state is entered at 306. Once the reset is complete at state 306, then the state 302 is again entered. If the “GO” bit signaling transaction start is set, then the pending transaction is executed at state 308. Once the transaction is completed at state 308, then the state moves back to state 304 to wait for a pending transaction. If an “Idle Period Start” time occurs during state 304, then state 310 is entered and the state machine waits for an expiration of the frame timer so that the state machine returns to state 302.

In some embodiments embedded USB HC applications are possible that are not advantageous with current USB HCs. For example, by using USB HCs according to some embodiments USB HCs may be proliferated for uses such as Wi-Fi® configurations and/or applications requiring additional flash memory (for example, NAND flash memory).

In some embodiments USB HC state machines may be implemented in software, hardware, and/or firmware, for example (including combinations of one or more of software, hardware, and/or firmware, for example).

Although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, the interfaces that transmit and/or receive signals, etc.), and others.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Although flow diagrams and/or state diagrams may have been used herein to describe embodiments, the inventions are not limited to those diagrams or to corresponding descriptions herein. For example, flow need not move through each illustrated box or state or in exactly the same order as illustrated and described herein.

The inventions are not restricted to the particular details listed herein. Indeed, those skilled in the art having the benefit of this disclosure will appreciate that many other variations from the foregoing description and drawings may be made within the scope of the present inventions. Accordingly, it is the following claims including any amendments thereto that define the scope of the inventions.

What is claimed is:

1. A method comprising:
sending a signal to start a current time frame for a Universal Serial Bus host controller;
after the sending, entering a period during which a pending transaction may be transmitted by the host controller;
if a transaction has been formed, transmitting the formed transaction during the entered period; and
when less than a maximum transfer period remains between a current time and a start of a next time frame, refraining from transmitting any additional formed transactions during the current time frame.

2. The method of claim 1, further comprising repeating the sending, entering, transmitting and refraining for the next time frame.

3. The method of claim 1, wherein the sending includes broadcasting a “Start of Frame” token to an attached device.

4. The method of claim 1, further comprising determining that the transaction has been formed in response to a bit written in a register.

5. The method of claim 1, wherein if a direction is out, then capturing a device's response token.

6. The method of claim 1, wherein if a direction is in, then capturing returned data.

7. The method of claim 1, wherein upon completion of the transmitting of the formed transaction, if at least a maximum transfer period remains between the current time and the start of a next time frame, then transmitting an additional formed transaction during the entered period.

8. A Universal Serial Bus host controller comprising:
a set of registers;
a memory to buffer read data or written data; and
a processor to:
send a signal to start a current time frame;
after the sending, enter a period during which a pending transaction may be transmitted by the host controller;
if a transaction has been formed, transmit the formed transaction during the entered period; and
when less than a maximum transfer period remains between a current time and a start of a next time frame, to refrain from transmitting any additional formed transactions during the current time frame.

9. The Universal Serial Bus host controller of claim 8, the processor further to repeat the sending, entering, transmitting and refraining for the next time frame.

10. The Universal Serial Bus host controller of claim 8, wherein the sending includes broadcasting a “Start of Frame” token to an attached device.

11. The Universal Serial Bus host controller of claim 8, the processor further to determine that the transaction has been formed in response to a bit written in the set of registers.

12. The Universal Serial Bus host controller of claim 8, wherein if a direction bit stored in the set of registers indicates an out condition, the processor to capture a device's response token.

13. The Universal Serial Bus host controller of claim 8, wherein if a direction bit stored in the set of registers indicates an in condition, the processor to capture returned data in the memory.

14. The Universal Serial Bus host controller of claim 8, wherein upon completion of the transmitting of the formed transaction, if at least a maximum transfer period remains between the current time and the start of a next time frame, then the processor to transmit an additional formed transaction during the entered period.

15. The Universal Serial Bus host controller of claim 8, wherein the set of registers includes a control/status register, a data register, an address register, and a physical interface device register.

16. A system comprising:
a USB host controller; and
a USB device attached to the USB host controller;
wherein the USB host controller is to:
send a signal to start a current time frame;
after the sending, enter a period during which a pending transaction may be transmitted by the host controller;
if a transaction has been formed, transmit the formed transaction during the entered period; and
when less than a maximum transfer period remains between a current time and a start of a next time frame, to refrain from transmitting any additional formed transactions during the current time frame.

17. The system of claim 16, the USB host controller further to repeat the sending, entering, transmitting and refraining for the next time frame.

18. The system of claim 16, wherein the sending includes broadcasting a “Start of Frame” token to the USB attached device.

19. The system of claim 16, wherein upon completion of the transmitting of the formed transaction, if at least a maximum transfer period remains between the current time and the start of a next time frame, then the USB host controller to transmit an additional formed transaction during the entered period.

20. An article comprising:
a computer readable medium having instructions thereon which when executed cause a computer to:
send a signal to start a current time frame for a Universal Serial Bus host controller;
after the sending, enter a period during which a pending transaction may be transmitted by the host controller;
if a transaction has been formed, transmit the formed transaction during the entered period; and
when less than a maximum transfer period remains between a current time and a start of a next time frame, refrain from transmitting any additional formed transactions during the current time frame.

21. The article of claim 20, the computer readable medium having instructions thereon which when executed further cause a computer to repeat the sending, entering, transmitting and refraining for the next time frame.

22. The article of claim 20, the computer readable medium having instructions thereon which when executed further cause a computer to capture a device's response token if a direction is out.

23. The article of claim 20, the computer readable medium having instructions thereon which when executed further cause a computer to capture returned data if a direction is in.

24. The article of claim 20, the computer readable medium having instructions thereon which when executed further cause a computer to transmit an additional formed transaction during the entered period upon completion of the transmitting of the formed transaction if at least a maximum transfer period remains between the current time and the start of a next time frame.
